(19) United States
(12) Patent Application Publication
(10) Pub. No.: US 2026/0236744 A1
(43) Pub. Date: Aug. 13, 2026

(54) ADAPTIVE HYBRID ARTIFICIAL INTELLIGENCE

(71) Applicant: QUALCOMM Incorporated, San Diego, CA (US)

(72) Inventors: Shuai ZHANG, San Diego, CA (US); Liangping MA, San Diego, CA (US); Yingyong QI, San Diego, CA (US)

(21) Appl. No.: 19/049,809

(22) Filed: Feb. 10, 2025

(51) Int. Cl. G06N 3/0455; G06N 3/0495; H04L 67/1008

(52) U.S. Cl. CPC G06N 3/0455; G06N 3/0495; H04L 67/1008

(57) ABSTRACT

Systems and techniques are described herein for machine learning processing. For example, a computing device can process, using an encoder, data stored in the at least one memory of an apparatus to generate a first feature map; obtain a second feature map from a plurality of feature maps associated with processed data from a second device, wherein the second feature map includes metadata indicating how to combine the second feature map with at least one other feature map; process the first feature map and the second feature map to generate a combined feature map based on the metadata, wherein the combined feature map is a concatenation or cross-attention combination of the first feature map and the second feature map; and process the combined feature map to perform a task.

### TECHNICAL FIELD

The present disclosure generally relates to processing information using artificial intelligence, such as one or more machine learning models. For example, aspects of the present disclosure relate to systems and techniques for processing information using adaptive hybrid artificial intelligence (e.g., an artificial intelligence or machine learning system configured to process information using multiple devices).

### BACKGROUND

Machine learning models generally rely on resource intensive operations to perform tasks. For example, many machine learning models require significant computational resources, such as high processing power, memory, and storage. The computational resources required to operate some machine learning models can make the machine learning models poorly equipped to operate on portable electronic devices such as phones, tablets, laptops, etc., which generally have fewer computational resources and limited batteries. Oftentimes, compromises in quality (e.g., accuracy in outputs or function) to machine learning models are made to allow machine learning models to operate on portable electronic devices.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for machine learning processing is provided. The apparatus includes at least one memory and at least one processor coupled to the at least one memory and configured to: process, using an encoder, data stored in the at least one memory of the apparatus to generate a first feature map; obtain a second feature map from a plurality of feature maps associated with processed data from a second device, wherein the second feature map includes metadata indicating how to combine the second feature map with at least one other feature map; process the first feature map and the second feature map to generate a combined feature map based on the metadata, wherein the combined feature map is a concatenation or cross-attention combination of the first feature map and the second feature map; and process the combined feature map to perform a task.

In some aspects, an apparatus for machine learning processing is provided. The apparatus includes at least one memory and at least one processor coupled to the at least one memory and configured to: process a text query to generate a first feature map; process local data of the apparatus to generate a second feature map; determine, based on performance parameters of the apparatus, to transmit the first feature map and the second feature map to be processed by a machine learning model of a second device; and transmit the first feature map and the second feature map.

In some aspects, a method for machine learning processing is provided. The method includes: processing, using an encoder, data stored in memory of a first device to generate a first feature map; obtaining a second feature map from a plurality of feature maps associated with processed data from a second device, wherein the second feature map includes metadata indicating how to combine the second feature map with at least one other feature map; processing the first feature map and the second feature map to generate a combined feature map based on the metadata, wherein the combined feature map is a concatenation or cross-attention combination of the first feature map and the second feature map; and processing the combined feature map to perform a task.

In some aspects, a method for machine learning processing is provided. The method includes: processing a text query to generate a first feature map; processing local data of a first device to generate a second feature map; determining, based on performance parameters, to transmit the first feature map and the second feature map to be processed by a machine learning model of a second device; and transmitting the first feature map and the second feature map.

In some aspects, a non-transitory computer-readable medium is provided having stored thereon instructions that, when executed by at least one processor, cause the at least one processor to: process, using an encoder, data stored in the at least one memory of the apparatus to generate a first feature map; obtain a second feature map from a plurality of feature maps associated with processed data from a second device, wherein the second feature map includes metadata indicating how to combine the second feature map with at least one other feature map; process the first feature map and the second feature map to generate a combined feature map based on the metadata, wherein the combined feature map is a concatenation or cross-attention combination of the first feature map and the second feature map; and process the combined feature map to perform a task.

In some aspects, a non-transitory computer-readable medium is provided having stored thereon instructions that, when executed by at least one processor, cause the at least one processor to: process a text query to generate a first feature map; process local data of the apparatus to generate a second feature map; determine, based on performance parameters of the apparatus, to transmit the first feature map and the second feature map to be processed by a machine learning model of a second device; and transmit the first feature map and the second feature map.

In some aspects, an apparatus for machine learning processing is provided. The apparatus includes: means for processing, using an encoder, data stored in memory of a first device to generate a first feature map; means for obtaining a second feature map from a plurality of feature maps associated with processed data from a second device, wherein the second feature map includes metadata indicating how to combine the second feature map with at least one other feature map; means for processing the first feature map and the second feature map to generate a combined feature map based on the metadata, wherein the combined feature map is a concatenation or cross-attention combination of the first feature map and the second feature map; and means for processing the combined feature map to perform a task.

In some aspects, an apparatus for machine learning processing is provided. The apparatus includes: means for processing a text query to generate a first feature map; means for processing local data of a first device to generate a second feature map; means for determining, based on performance parameters, to transmit the first feature map and the second feature map to be processed by a machine learning model of a second device; and means for transmitting the first feature map and the second feature map.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF FIGURES

Illustrative aspects of the present application are described in detail below with reference to the following figures:

FIG. 1 illustrates an example implementation of a system-on-a-chip (SOC), in accordance with aspects of the present disclosure;

FIG. 2 is a block diagram illustrating an example hybrid artificial intelligence system, in accordance with aspects of the present disclosure;

FIGS. 3A-3B are block diagrams illustrating example combining of feature maps from one or more devices, in accordance with aspects of the present disclosure;

FIG. 4 is a block diagram illustrating an example encoder, in accordance with aspects of the present disclosure;

FIG. 5 is a block diagram illustrating an example decoder, in accordance with aspects of the present disclosure;

FIG. 6 is a block diagram illustrating another example hybrid artificial intelligence system, in accordance with aspects of the present disclosure;

FIG. 7 is a flow diagram illustrating an example process for a hybrid artificial intelligence system, in accordance with aspects of the present disclosure;

FIG. 8 is a flow diagram illustrating another example process for a hybrid artificial intelligence system, in accordance with aspects of the present disclosure;

FIG. 9 is a block diagram illustrating an example neural network, in accordance with aspects of the present disclosure;

FIG. 10 is a block diagram illustrating an example convolutional neural network, in accordance with aspects of the present disclosure;

FIG. 11 is a block diagram illustrating an example transformer architecture, in accordance with aspects of the present disclosure;

FIG. 12 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, machine learning models generally rely on resource intensive operations to perform tasks. For example, many machine learning models require significant computational resources, such as high processing power, memory, and storage. The computational resources required to operate some machine learning models can make the machine learning models poorly equipped to operate on portable electronic devices such as phones, tablets, laptops, etc., which generally have fewer computational resources and limited batteries. Oftentimes, compromises in quality (e.g., accuracy in outputs or function) to machine learning models are made to allow machine learning models to operate on portable electronic devices.

Integrating machine learning models operated using remote computing resources can allow portable electronic devices access to machine learning models which the portable electronic devices would be unable to operate. For example, remote computing resources (e.g., cloud services, cloud platforms, etc.) can provide portable electronic devices access to greater processing power, memory, and storage allowing the portable electronic devices the ability to use machine learning models which would otherwise be too resource intensive to operate locally.

Remote computing resources can allow for tasks of machine learning models to be split between different machine learning models or different devices (e.g., to perform distributed computing). For example, different tasks can be split between machine learning models or devices. In such an example, inferences (e.g., hybrid inferences) of the machine learning models can be determined using multiple machine learning models operating on different devices. For example, hybrid inferences can include using local and cloud-based processing resources to generate the inferences. In such an example, inferences where low-latency responses are preferable can be performed locally on a device (e.g., locally on a smartphone, computer, tablet, etc.). In examples, where the inferences are resource-intensive (e.g., requiring more processing power than is available on the local device), inferences can be generated using cloud-based processing resources.

Systems, apparatuses, electronic devices, methods (also referred to as processes), and computer-readable media (collectively referred to herein as “systems and techniques”) are described herein for providing machine adaptive hybrid artificial intelligence (AI). In some aspects, the systems and techniques can include a local device (e.g., a mobile device such as a smartphone, a tablet, a laptop computer, a desktop computer, etc.) and a remote device (e.g., an edge device, a cloud server, another computer, etc.). The remote device can include one or more machine learning models, referred to herein as remote machine learning models. The local device can include one or more machine learning models, referred to herein as local machine learning models. The local machine learning model can be operated locally using one or more processors of the local device. The remote machine learning models can be operated using one or more processors of the remote device.

In some aspects, the local device can refer to the device used by the user for which a task is to be performed. In some examples, the user can request performance of a task by providing a text query. In other examples, performance of the task is automatic and/or based on sensor data captured by the local device. In further examples, performance of the task can be based on a message or command received by the local device from another device, such as the remote device or another device.

In some aspects, the remote device can refer to any other device, service, system, apparatus, etc. in communication with the local device. For example, the remote device can refer to a cloud server in communication with the local device.

The systems and techniques can include using the machine learning model operating on the local device and the machine learning models operating on the remote device to perform a task. For example, the remote machine learning model and the local machine learning model can perform different amounts of processing, or generate different amounts or resolutions of inferences, to perform a task. For example, a user can provide a text query (also referred to as a user query) to the local device. The text query can include a request to perform a task. The local machine learning model can process the text query and local data of the local device (e.g., sensor data associated with the local device, data stored by the local device, etc.) using an encoder of the local device (e.g., the local machine learning model, or a local encoder) to generate a feature map associated with the text query and the local data. The remote device can process remote data to generate one or more remote feature maps. For example, the remote device can use an encoder (e.g., referred to as the remote encoder, or the remote machine learning model) to generate feature maps (referred to as remote feature maps). In some examples, the local device can provide the local data or text query to the remote device to generate the remote feature maps.

In some aspects, the remote device can generate a plurality of remote feature maps of different qualities (e.g., different resolutions). For instance, a remote feature map of a higher resolution can include more features (e.g., a larger feature map) than a lower resolution remote feature map. In one illustrative example, a coarse feature map can represent a feature map with a lower resolution than a fine feature map. In some aspects, the remote device can include a compression engine to generate the plurality of remote feature maps of different resolutions. For example, the remote device can process the remote data and/or the user query to generate a remote feature map. The compression engine can process the feature map to generate lower resolution representations of the remote feature map. The compression engine can perform various compression techniques on feature maps or representations of feature maps, such as quantization, pruning, low-rank approximation, etc.

In some aspects, the systems and techniques can include determining a remote feature map from a plurality of remote features to transmit to the local device. For example, the systems and techniques can determine whether to transmit a remote feature map from the plurality of remote feature maps based on a connection between the remote device and the local device. In such an example, the remote device and the local device can be connected using various wireless connection technologies such as Wi-Fi. The systems and techniques can include determining which feature map to transmit to the local device based on a connection speed or bandwidth of the connection between the local device and the remote device.

In some aspects, the systems and techniques can include determining which remote feature maps to transmit to the local device based on a task to be performed using the remote machine learning model or the local machine learning model. For example, a first task such as object detection can require a higher resolution feature map than a second task, such as summarizing a text paragraph.

In some aspects, the systems and techniques can include determining which remote feature maps to transmit based on a local device condition. For example, the systems and techniques can include sending lower resolution remote feature maps (e.g., a coarse feature map) when the local device is in a low-power mode, when the local device has a battery or memory storage value below a threshold amount, based on a temperature of the local device, or based on available processing resources of the local device.

In some aspects, the systems and techniques can include combining feature maps (e.g., combining a local feature map and a remote feature map) using various techniques. For example, the systems and techniques can include using cross-attention to process and relate information from remote feature maps and the local feature maps to combine the feature maps. The combined feature maps can be used to perform various tasks (e.g., the task requested in the user query). In some aspects, the systems and techniques can include combing the local feature map and the remote feature map using concatenation techniques. For example, the remote feature map can be appended to the remote feature map or vice versa. The concatenated (e.g., the combined feature map) can be processed by a decoder of the local device (e.g., a decoder of the local machine learning model) to perform the task requested to be performed from the text query.

In some aspects, the systems and techniques can include techniques for transporting (e.g., transmitting) scalable feature maps. For example, the systems and techniques can use telecommunication standards such as the 3rd Generation Partnership Project (3GPP) techniques to transmit remote feature maps to the local device using bit-incremental delivery techniques. In some aspects, the systems and techniques can include determining a quality level of the remote feature map to transmit based on a network connection of the local device and the remote device.

In some aspects, the systems and techniques can include using real-time transport protocol (RTP) techniques to transmit remote feature maps to the local device. For example, the remote feature maps can be included in an RTP packet with an RTP payload type indicating parameters of the remote feature map. For example, the parameters can include a computing graph (e.g., which local machine learning model) to which the remote feature map should be applied, a layer identity of the remote feature map (e.g., layer information indicating an importance of features from the remote feature map), and quantization parameters of the remote feature map. In some aspects, the systems and techniques can use different layers of feature maps (e.g., the remote feature map) to generate protocol data units (PDUs) including layer information indicating an importance level of the layers or features from the feature map.

Various aspects of the present disclosure will be described with respect to the figures below.

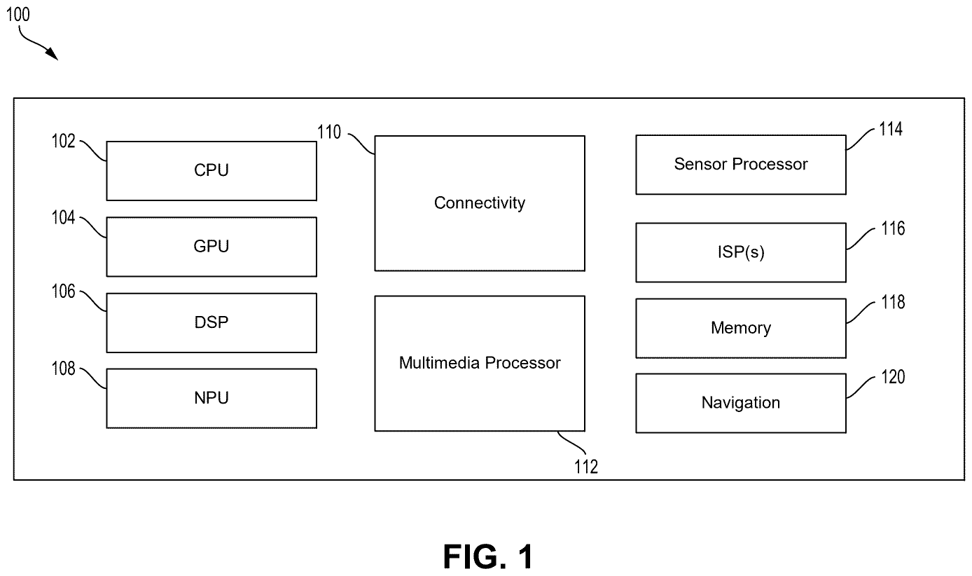

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform audio processing, such as denoising audio signals of wind noise, using machine learning techniques according to aspects of the present disclosure discussed herein. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, audio processing and analysis, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for audio processing, such as denoising of audio signals, can be used to preserve low-frequency audio signals in audio signals with noise, to achieve higher quality audio signals. Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

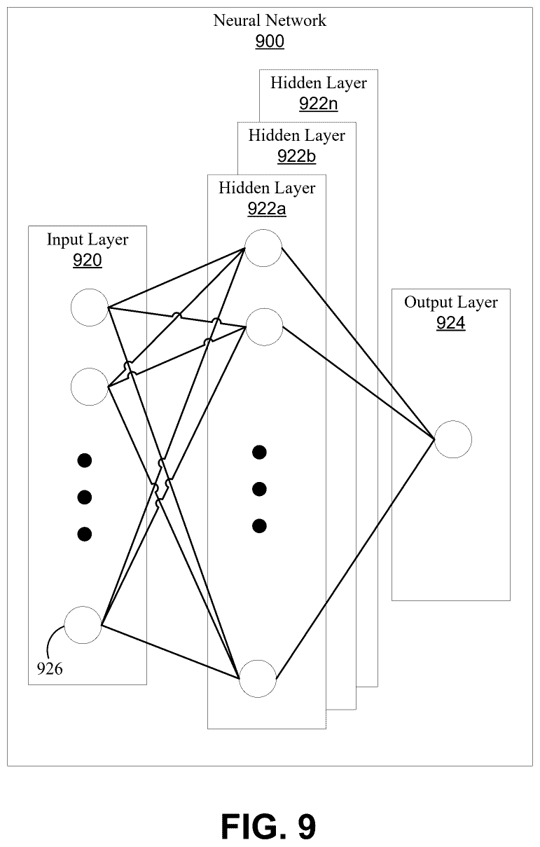

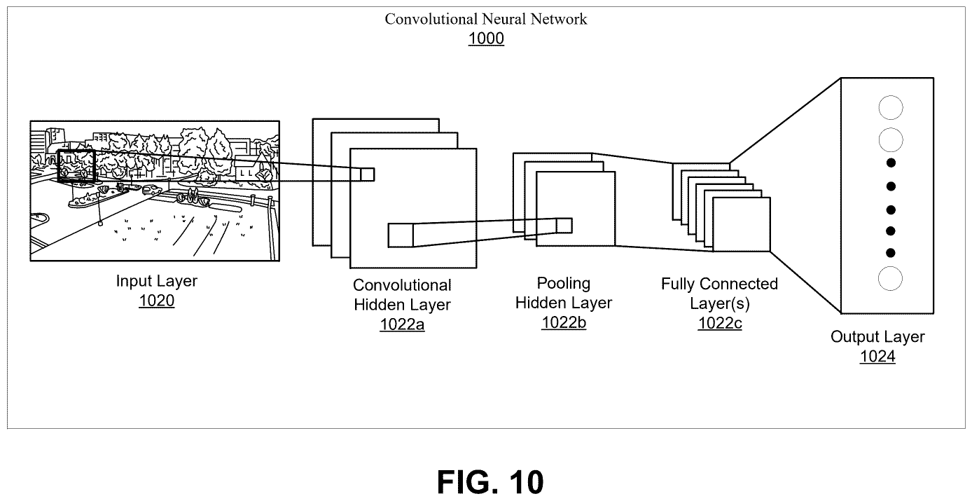

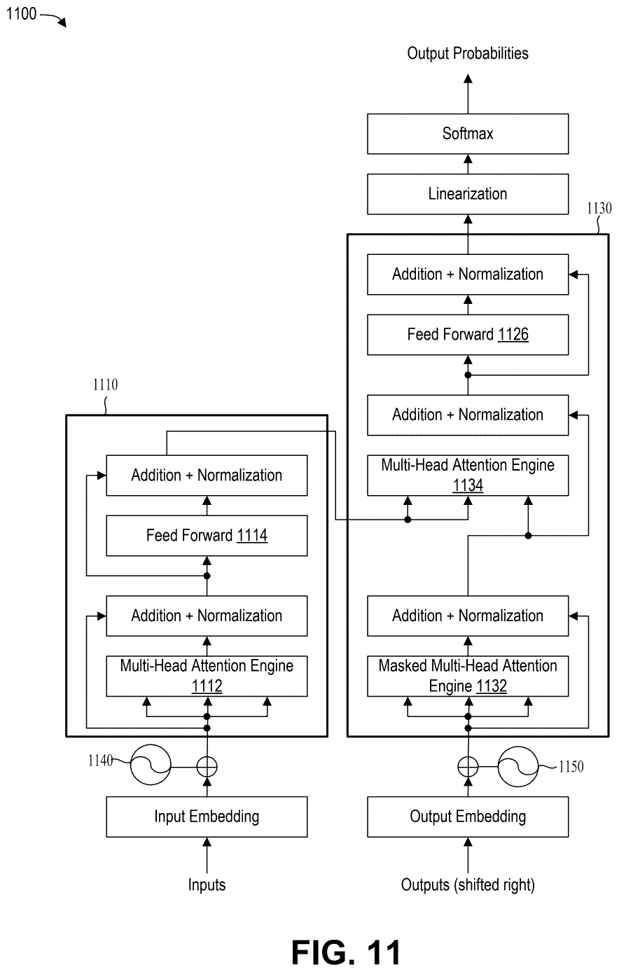

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 9, FIG. 10, FIG. 11.

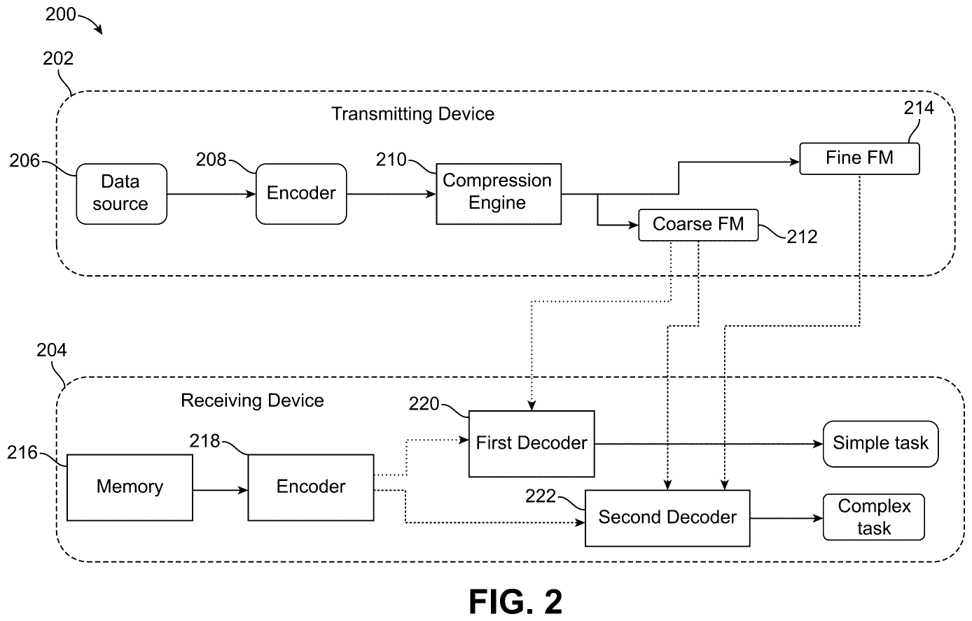

The SOC 100 of FIG. 1 can be used to perform various operations of the transmitting device 202 or the receiving device 204 of FIG. 2. For example, the SOC 100 can include the receiving device 204 or the transmitting device 202 and can perform the various machine learning model operations described in the descriptions of FIGS. 2, 3A, 3B, and 4-8.

FIG. 2 is a block diagram illustrating an example hybrid artificial intelligence system 200. The block diagram includes a transmitting device 202 and a receiving device 204. The transmitting device 202 can be a device in communication with the receiving device 204. For example, the transmitting device 202 can be a cloud server providing a web application or cloud service to the receiving device 204. The web application or cloud service can include a machine learning model for performing various tasks for or to assist with tasks to be performed using the receiving device 204.

The transmitting device 202 can include a data source 206, an encoder 208, and a compression engine 210. The data source 206 can receive data from various sensors, applications, devices etc. associated with the transmitting device 202. For example, the transmitting device 202 can be a cloud server for a set of traffic cameras. In such an example, the transmitting device 202 can receive data (e.g., videos or images) from the traffic cameras as the data source. The transmitting device 202 can provide as input, data from the data source 206 to the encoder 208. In some examples, the encoder 208 is part of a machine learning model operated using the transmitting device 202.

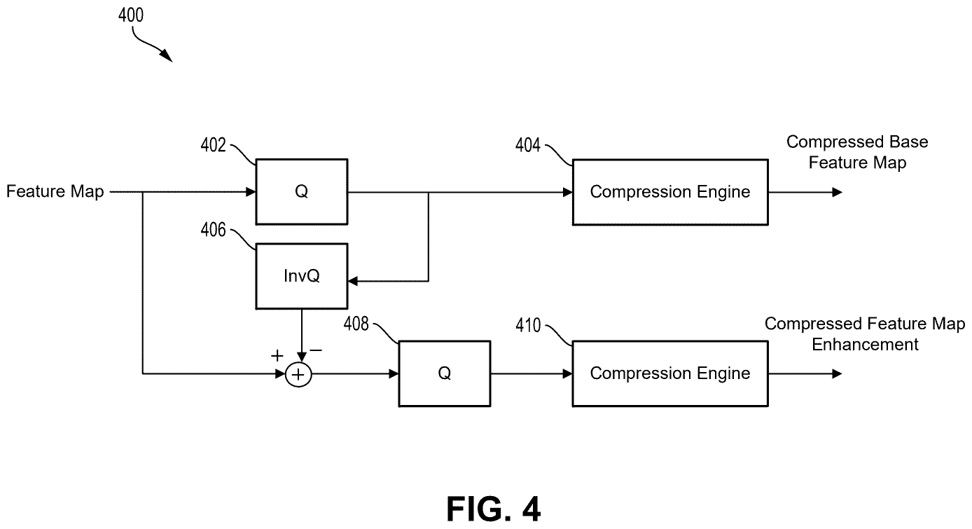

The encoder 208 can process data from the data source 206 to generate a feature map (referred to as the transmitter feature map). In some examples, the encoder 208 can process data from the data source 206 to generate multiple feature maps. In some examples, the encoder 208 is part of a multi-modal machine learning model. For example, the transmitting device 202 can include a plurality of encoders. Each encoder of the plurality can be associated with a different type of input to be processed (e.g., images, audio, video, etc.) or different machine learning models (e.g., a large language model (LLM), a speech to text model, a vision transformer (ViT), etc.). Further description of the encoder 208 is provided in the description of FIG. 4.

The compression engine 210 can receive the feature map output by the encoder 208. The compression engine 210 can compress the feature map output by the encoder 208. In some examples, the compression engine 210 can compress the feature map into various different compressed feature maps with different quality (e.g., different resolutions). For example, the compression engine 210 can compress the feature map into a coarse feature map 212 and a fine feature map 214. The coarse feature map 212 can be a lower resolution (e.g., lower resolution than the fine feature map 214) representation of the feature map output by the encoder 208. For example, the coarse feature map 212 can have less features included in the coarse feature map 212 than the fine feature map 214. In further examples, the coarse feature map 212 and the fine feature map 214 can be different layers of a feature map. For example, the coarse feature map 212 can be a base layer of a feature map. The fine feature map 214 can be an additional layer to provide additional information associated with the compressed and encoded data from the data source 206. The coarse feature map and the fine feature map can describe the same feature map at different quality levels (e.g., different resolutions). In further examples, the encoder 208 can include the compression engine 210. In further examples, the data source 206 can include feature maps, and the encoder 208 can receive feature maps from the data source 206.

The receiving device 204 can receive feature maps from the transmitting device 202. For example, the receiving device 204 can include memory 216 storing data, an encoder 218, a first decoder 220, and a second decoder 222. For example, the receiving device 204 can include a sensor to capture data and store the data in memory 216.

The receiving device 204 can provide data from the memory 216 to the encoder 218 of the receiving device 204. The encoder 218 can be part of a machine learning model. For example, the machine learning model can be a multi-modal machine learning model. The encoder 218 can be one of a plurality of encoders of the receiving device 204. For example, the receiving device 204 can include a plurality of encoders with each encoder associated with a different type of input to be processed (e.g., a first encoder for images, a second encoder for video, etc.). The encoder 218 can generate a feature map based on the data from memory 216. In some examples, a user can provide a user query. In such an example, the feature map can be based on the user query or the data from memory 216.

The receiving device 204 and the transmitting device 202 can be in communication with the other using various communication protocols and techniques such as RTP. In such an example, the receiving device 204 and the transmitting device 202 can send RTP packets, or other messages, to one another to determine a quality of connection (e.g., connection speed, connection strength, etc.) between the receiving device 204 and the transmitting device 202. The transmitting device 202 (or the receiving device 204) can determine whether to transmit a feature map to the receiving device 204 based on a network connection between the receiving device 204 and the transmitting device 202. For example, the transmitting device can determine, based on a threshold connection speed or bandwidth of the network connection between the receiving device 204 and the transmitting device 202, whether to transmit a feature map. The transmitting device 202 (or the receiving device 204) can determine which feature map to transmit. For example, when the network connection is weak (e.g., the connection speed is below speed threshold) the transmitting device 202 can determine to transmit the coarse feature map 212. In such an example, the coarse feature map 212 can be selected to be sent based on a size (e.g., file size) of the coarse feature (e.g., because the coarse feature map 212 includes less features than the fine feature map 214, the coarse feature map 212 is a smaller file size).

In further examples, the transmitting device 202 can include more feature maps of varying resolution (e.g., a plurality of feature maps) than the coarse feature map 212 and the fine feature map 214. In such an example, the transmitting device 202 (or the receiving device 204) can determine which feature map from the plurality of feature maps to provide to the receiving device 204. In further examples, the transmitting device 202 can determine which feature map to provide to the receiving device 204 based on the task to be performed. In such an example, a first task can use the coarse feature map 212 and a second task can use the fine feature map 214. In another example, the transmitting device 202 can determine which feature map to provide to the receiving device 204 based on a device condition of the receiving device 204. Device conditions can include available processing resources, available storage, battery level, mode of operation of the receiving device 204 (e.g., low battery mode, reduced communication modes, etc.), temperature of the receiving device 204, etc.

The receiving device 204 (or the transmitting device 202) can determine which decoder (e.g., the first decoder 220, the second decoder 222, etc.) of the receiving device 204 to use to process the transmitted feature map (e.g., the feature map generated by the transmitting device 202). For example, the first decoder 220 can be associated with tasks using transmitted feature maps having a predetermined range of resolution or quality. In further examples, the first decoder 220 can be associated with tasks which use lower resolution or quality feature maps to perform (e.g., simpler tasks) as compared to the second decoder 222. For example, the transmitting device 202 can provide the coarse feature map 212 to the first decoder 220. The second decoder 222 can be associated with more complex tasks (e.g., task which use feature maps having a higher resolution compared to feature maps used by the first decoder 220). In other examples, the receiving device 204 can determine which decoder to use to process a received feature map based on the feature maps received (e.g., feature maps within a first range of resolutions can be processed using the first decoder 220 and feature maps within a second range of resolutions can be processed using the second decoder 222).

In some examples, the transmitted feature maps received from the transmitting device 202 can include metadata associated with a quality level of the transmitted feature maps (e.g., resolution). The metadata can include information associated with how to combine the transmitted feature maps with feature maps generated by the receiving device 204 and which decoder of the receiving device to use to process the combined feature map.

In another example, such as when the coarse feature map 212 and the fine feature map 214 are layers of a feature map (e.g., coarse feature map 212 including or being a base layer representing a low quality version of the feature map and the fine feature map 214 including or being an additional layer representing a high quality version of the feature map), both the coarse feature map 212 and the fine feature map 214 can be provided to the second decoder 222 of the receiving device 204 to be processed. For example, when the network connection between the transmitting device 202 and the receiving device 204 is above a predetermined connection speed or bandwidth threshold, the receiving device 204 can receive the coarse feature map 212 and the fine feature map 214 to be processed by the second decoder 222. The output of the first decoder 220 or the second decoder 222 can be the performance of the task. For example, when the task is to generate a transcript from a video, the output can be the transcript or tokenized representation of the transcript.

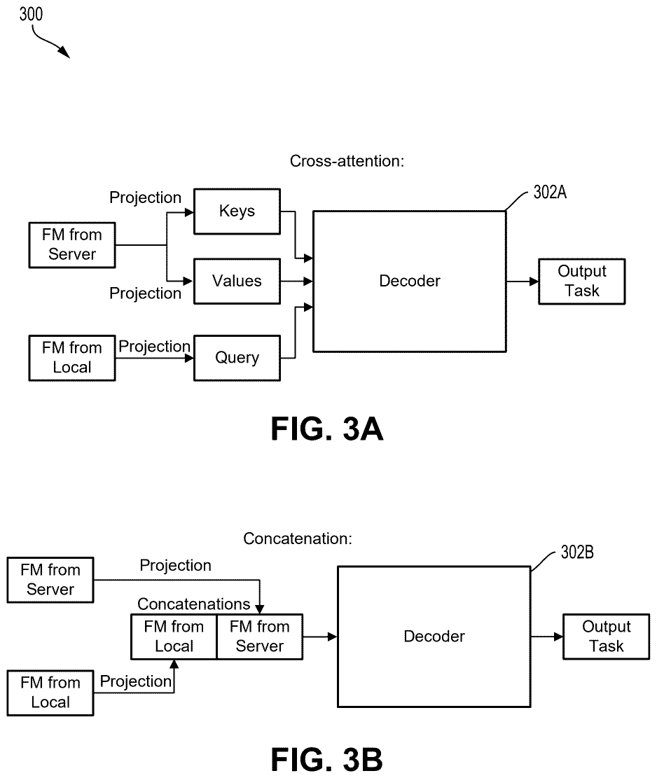

In some examples, the first decoder 220 and the second decoder 222 can combine the transmitted feature map (e.g., one or more of the coarse feature map 212 and the fine feature map 214) and the feature map generated by the encoder 218 of the receiving device 204. Further description of the combining feature maps using cross-attention and concatenation is provided in the description of FIG. 3A-3B.

FIG. 3A is a block diagram illustrating cross-attention of feature maps from a first device (e.g., a server, the transmitting device 202 of FIG. 2) and a second device (e.g., a computer, smartphone, other device operated by a user, the receiving device 204 of FIG. 2). By way of non-limiting example, the feature map (or a projection of the feature map) of the first device and the feature map (or projection of the feature map) of the second device can be provided to the decoder 302A as a cross-attention combination. For example, the feature map of the first device can be provided to the decoder 302A as key-value pairs and the feature map of the second device can be provided to the decoder 302A as queries. The decoder 302A can process the feature maps to perform a task. For example, the decoder 302A can be part of a machine learning model of the first device or the second device (e.g., a multi-modal machine learning model). The output of the decoder 302A can be a task or action requested by a user or device to be performed.

FIG. 3B is a block diagram illustrating concatenation of feature maps generated by a first device and a second device. In FIG. 3B, a feature map generated by the first device can be appended to a feature map generated by the second device to form a combined feature map. The combined feature map can be provided to decoder 302B to be processed. The decoder 302B can process the combined feature map to perform a task. For example, the decoder 302B can be part of a machine learning model. The output of the decoder 302B can be a task requested by a user or device to be performed.

FIG. 4 is a block diagram illustrating an example compression system 400 for compressing feature maps. In some examples, the compression system 400 can be the compression engine 210 of FIG. 2. The compression system 400 can receive as input a feature map. The compression system 400 can provide the feature map to a quantizer 402 of the compression system 400. The quantizer 402 can convert features of the feature map into coarser values (e.g., to generate a quantized representation of the feature map). For example, the feature map can include floating-point values. The quantizer 402 can convert the floating-point value representations of the features into integers. The quantized representation of the feature map can be received by a compression engine 404 to generate a compressed base feature map. For example, the compressed base feature map can be the coarse feature map 212 of FIG. 2 representing a first set of features of the feature map.

The compression system 400 can provide the quantized representation of the feature map to an inverse quantizer 406 to convert the quantized representation of the feature map into a form similar to the feature map received by the quantizer 402. For example, the feature map output by inverse quantizer 406 can be similar in some examples while not being identical to the initially received feature map because the resolution lost from converting float values to integers. The compression system 400 can determine the difference between the initially received feature map and the inverse quantized feature map to determine values associated with the resolution lost during quantization. The difference (e.g., the values associated with the resolution lost during quantization) can be quantized using quantizer 408 to transform the values associated with the lost resolution into an integer representation. The integer representation can be compressed using compression engine 410 to generate a compressed feature map associated with additional values of features of the feature map (e.g., increased resolution of the features of the feature map). In such an example, the output of the compression engine 410 can be the fine feature map 214 of FIG. 2.

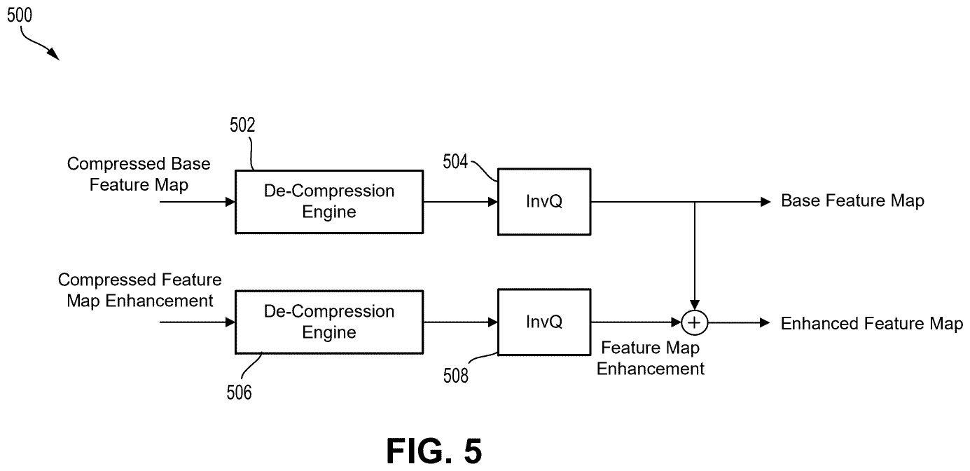

FIG. 5 is a block diagram representation of a decoder 500. The decoder 500 can be the first decoder 220 or the second decoder 222 of FIG. 2. In further examples, the decoder 500 can be an additional decoder or part of the first decoder 220 or the second decoder 222 for de-compressing and inverse quantizing compressed feature maps. The decoder 500 can receive compressed feature maps (e.g., the coarse feature map 212 of FIG. 2, the fine feature map 214 of FIG. 2, the compressed feature maps of FIG. 4, etc.) and output de-compressed (e.g., uncompressed) representations of the compressed feature maps. In some examples, the output decoder 500 can be provided to a machine learning model to perform a task. In further examples, the decoder 500 is part of a machine learning model. In such an example, FIG. 5 can illustrate part of the decoder 500, and the outputs of the illustrated part of the decoder (e.g., the de-compressed feature maps) can be further processed by the decoder to perform a task or action.

The decoder 500 includes a de-compression engine 502, 506 and an inverse quantizer 504, 508. The decoder 500 can receive a compressed base map (e.g., the coarse feature map 212 of FIG. 2) and a compressed feature map enhancement (e.g., the fine feature map 214 of FIG. 2) and de-compress the compressed base maps using one of the de-compression engine 502 or de-compression engine 506. The de-compression engine 502, 506 can use various de-compression techniques such as quantization decompression, Huffman coding decompression, etc. The decoder 500 can provide the de-compressed base feature map and feature map enhancement to the inverse quantizer 504 and 508. The output of the inverse quantizer can be a base feature map (e.g., the coarse feature map 212 of FIG. 2) and a feature map enhancement (e.g., the fine feature map). The decoder 500 can combine the base feature map and the feature map enhancement to generate a combined feature map. The combined feature map can more closely approximate the feature map provided to an encoder because the combined feature map includes the value representations of the features lost during quantization of the base feature map.

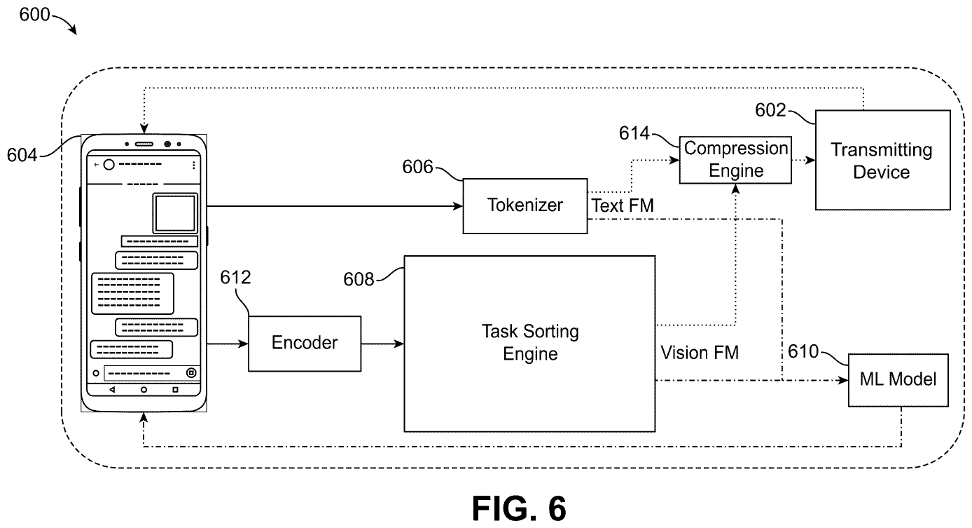

FIG. 6 is a block diagram example of a hybrid AI system 600. The hybrid AI system 600 can include a transmitting device 602 and a receiving device 604. The receiving device 604 can receive machine learning model outputs transmitted from the transmitting device 602. The receiving device 604 can be the receiving device 204 of FIG. 2. The transmitting device 602 can be the transmitting device 202 of FIG. 2.

A user can provide inputs to the receiving device 604, such as by providing a text query (also referred to as a user query) to the receiving device 604 to perform an action or task. The receiving device 604 can include a tokenizer 606, a machine learning model 610 (e.g., a machine learning model operating locally on the receiving device 604) a task sorting engine 608 (e.g., an AI task distinguisher), and a compression engine 614. In some examples, the compression engine 614 is part of the transmitting device 602. The receiving device 604 can process the text query using the tokenizer 606 to generate a plurality of tokens associated with the text query. The plurality of tokens can represent a feature map associated with the text query. The receiving device 604 can provide the plurality of tokens (also referred to as a text feature map) to the compression engine 614.

The receiving device 604 can provide data (e.g., sensor data) associated with the text query to the task sorting engine 608. The task sorting engine 608 determines whether a task should be performed using the transmitting device 602 (e.g., a machine learning model of the transmitting device 602) or the receiving device 604 (e.g., the machine learning model 610 of the receiving device 604). In some examples, the task sorting engine 608 can determine whether a task should be performed using the transmitting device 602 or the receiving device 604 based on performance parameters of the transmitting device. Performance parameters can include information associated with various operating conditions of the transmitting device 602 such as such as one or more of a current compute load, remaining battery power of the computing device, or temperature of the computing device.

In some examples, the receiving device 604 can use an encoder 612 to generate a feature map associated with the data. For example, the task sorting engine 608 can receive the feature map from the encoder 612. The task sorting engine 608 can process the feature map from the encoder 612 to determine whether the task should be performed by the receiving device 604 or the transmitting device 602. For example, the task sorting engine 608 can be a machine learning model trained to classify data and/or user queries. For example, the task sorting engine 608 can be a classification model or a rules-based model. In another example, the task sorting engine 608 can be a rules-based model to sort tasks based on the data used to perform the task. For example, the task sorting engine 608 can include rules to use the machine learning model 610 to perform tasks associated with text and to use the transmitting device 602 to perform tasks associated with video.

In examples where the task sorting engine 608 sorts the task to the machine learning model 610, the task sorting engine 608 can provide or route the output of encoder 612 to the machine learning model 610. For example, the output of encoder 612 can include a feature map associated with the data provided as input to the encoder 612. The machine learning model can receive the plurality of tokens associated with the text query (e.g., the text feature map). The machine learning model can process the feature map from the encoder 612 (or the data associated with the feature map) and the text feature map (or the text query) to perform a task. For example, the text query can ask the receiving device 604 to summarize an image. In such an example, the output of the machine learning model 610 can include a summary of objects depicted in the image.

In some examples, the task sorting engine 608 can determine whether to use the transmitting device 602 to perform tasks based on a condition of the receiving device 604 or a network connection between the receiving device 604 and the transmitting device 602. For example, when the network connection between the receiving device 604 and the transmitting device 602 is below a predetermined speed or bandwidth threshold, the task sorting engine 608 can determine to use the machine learning model 610 to perform tasks requested in the text query.

In another example, the task sorting engine 608 can determine the task or a portion of the task should be performed by the transmitting device 602. The task sorting engine can provide the output of the encoder 612 to the compression engine 614. The compression engine 614 can perform various compression techniques on the text feature map (e.g., tokenized representation of the text query or the text query) and the output of the encoder 612 (e.g., feature map representation of the output of the encoder 612) to prepare the feature maps to be provided to the transmitting device 602.

The transmitting device 602 can include a machine learning model. For example, the transmitting device 602 can include a multi-modal machine learning model. The transmitting device 602 can be a cloud server, cloud application, edge device, etc. The transmitting device 602 can include additional processing power to operate more resource intensive machine learning models which may be unable to operate on the receiving device 604. The machine learning model of the transmitting device 602 can de-compress and process the compressed feature maps output by the compression engine 614 to perform the task requested in the text query. The transmitting device 602 can provide a response to the receiving device 604 including results of performing the task. For example, when the task is to perform speech to text processing on an audio file, the output of the transmitting device 602 can include a text transcript of the audio file. The receiving device 604 can receive the response and provide the response to the user (e.g., by displaying the response on a screen of the receiving device 604).

In some examples, the receiving device 604 and the transmitting device can use RTP packets to transmit feature maps and the response from processing feature maps. For example, the receiving device 604 can use telecommunication standards such as the 3rd Generation Partnership Project (3GPP) techniques (e.g., 3GPP Technical Report 26.927 (5.2.2.2.2)) to transmit feature between the receiving device 604 and the transmitting device 602. The RTP packets transmitted by the receiving device 604 and the transmitting device 602 can be adaptive to the network connection between the receiving device 604 and the transmitting device 602. For example, when the network connection is poor (e.g., the network having a speed or bandwidth below a threshold), the receiving device 604 and the receiving device 604 can transmit RTP packets including feature maps with lower resolution (e.g., feature maps with fewer features or with fewer values).

In such an example, the transmitting device 602 or the receiving device can generate RTP packets with an RTP payload type indicating parameters of a feature map associated with the packet. For example, the parameters can include a computing graph (e.g., which machine learning model of the receiving device 604 or the transmitting device 602) to which the feature map should be applied, a layer identity of the feature map (e.g., layer information indicating an importance of features from the feature map), and quantization parameters of the feature map. In some examples, the RTP packets can use different layers of feature maps (e.g., the remote feature map) to form protocol data unit (PDU) Sets including layer information indicating an importance level of the layers or features from the feature maps. The layer information can be indicated in the RTP packets by mapping the layer to a value of a PDU Set Importance (PSI) field of an RTP header extension for PDU Set marking (e.g., 0 is for layer 0, 1 for layer 1, etc., at decreasing importance). When the network connection fall below a speed or bandwidth threshold, the network can drop layers of less importance (e.g., layer 1) to allow transmission of more important layers (e.g., layer 0).

The mapping from layer to PSI value is negotiated by the receiving device 604 and the transmitting device 602 at the session setup (e.g., via session description protocol SDP), and the Augmented Backus-Naur Form (ABNF) syntax for the SDP signaling can include: extensionname=“urn:3gpp:pdu-set-marking:rel-19”; extensionattributes=*3(format/“pdu-set-size”/“num-pdus-in-pdu-set”) [format SP] layer-mapping; format=“short”/“long”; layer-mapping=*([format SP] layerID:PSIvalue. Here extensionname identifies the RTP header extension, extensionattributes gives the syntax for the SDP signaling in in particular the layer-mapping attribute maps the layer ID (layerID) to a PSI value (PSIvalue).

A network entity can copy the layer information in the RTP header extension to a GTP-U (e.g., General Packet Radio Service Tunneling Protocol—User Plane) packet header of a GTP-U packet which includes the RTP packet and can be used to assist routers or a base station in routing and scheduling. In some examples, a network entity, the transmitting device 602, or the receiving device 604 can determine the layer information in the RTP header (e.g., payload type) and then indicate the payload type in a GTP-U packet header. In further examples, the PDUs in the PDU Set can be encoded with application layer FEC (AL-FEC) to reduce packet losses and to lower latency.

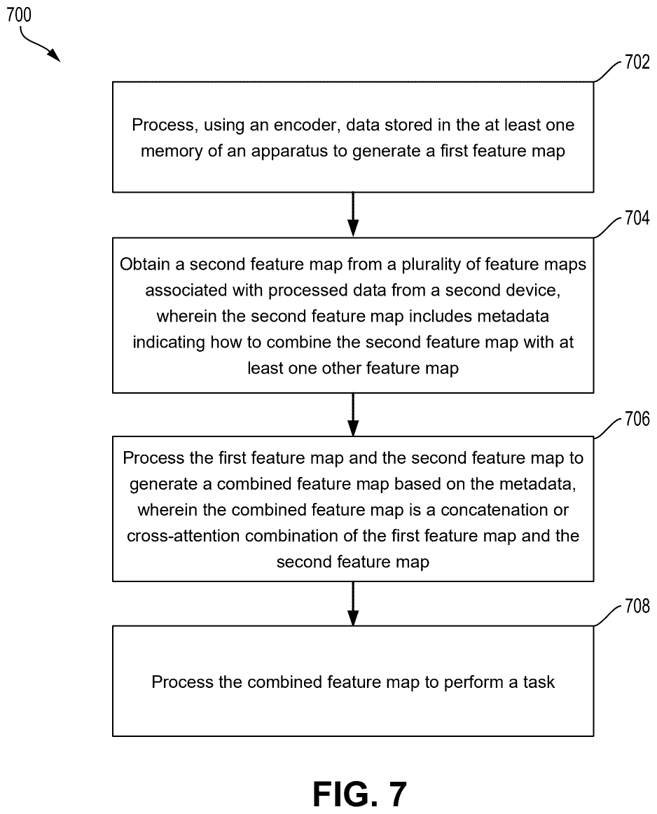

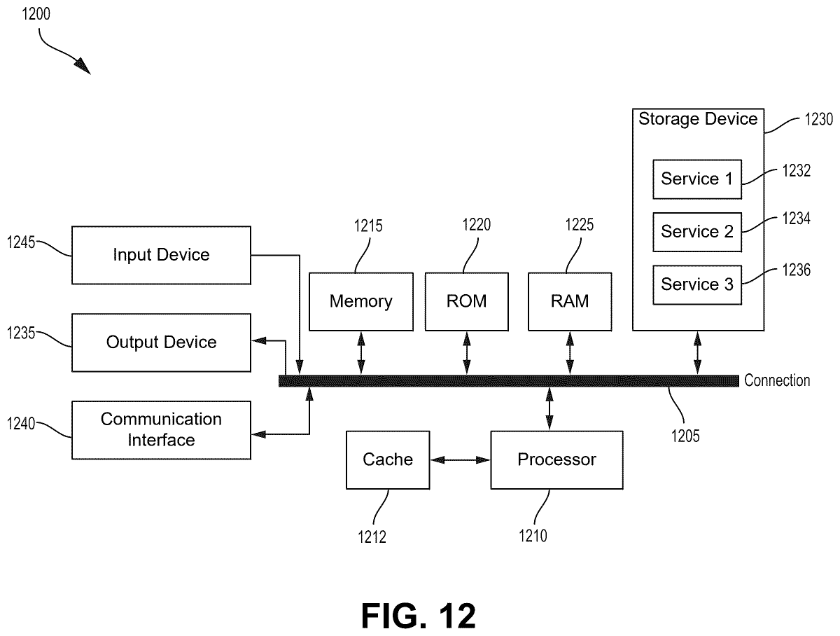

FIG. 7 is a flow chart illustrating an example of a process 700 for machine learning processing. The process 700 can be performed by a computing device (e.g., SOC 100 of FIG. 1, computing device or computing system 1200 of FIG. 12, etc.) or by a component or system (e.g., receiving device 204 or transmitting device 202 of FIG. 2, the compression system 400 of FIG. 4, the decoder 500 of FIG. 5, the neural network 900 of FIG. 9, the convolutional neural network 1000 of FIG. 10, the transformer 1100 of FIG. 11, etc.), a chipset, one or more processors central processing units (CPUs), digital signal processors (DSPs), graphics processing units (GPUs), any other type of processor(s), any combination thereof, or other component or system) of the computing device. The operations of the process 700 can be implemented as software components that are executed and run on one or more processors (e.g., processor 1210 of FIG. 12 or other processor(s)) of the computing device. Further, the transmission and reception of signals by the computing device in the process 700 can be enabled, for example, by one or more antennas, one or more microphones, and/or one or more transceivers (e.g., wireless transceiver(s)).

At block 702, the computing device (or component thereof) can process, using an encoder, data stored in the at least one memory of an apparatus to generate a first feature map. In some examples, the apparatus can be a first device or can be part of a first device. In some examples, the data can be local data of the computing device, such as sensor data from a sensor of the computing device.

At block 704, the computing device (or component thereof) can obtain a second feature map from a plurality of feature maps associated with processed data from a second device. In such an example, the second feature map can include metadata indicating how to combine the second feature map with at least one other feature map. In further examples, the first feature map can be obtained based on a task to be performed by a machine learning model. In such an example, the plurality of feature maps can include feature maps of different resolutions. For example, when the machine learning model is to perform a task requiring higher resolution feature maps, the computing device (or component thereof) can obtain a higher resolution feature map to use in performing the task. For example, the first feature map can be a coarse feature map (e.g., the coarse feature map 212 of FIG. 2) or a fine feature map (e.g., the fine feature map 214 of FIG. 2). In some examples, the second feature map from the plurality of feature maps is obtained based on a quality of a connection between the first device and the second device. In such an example, the quality of connection can include bandwidth, strength of the connection, connection speed, etc. When the quality of connection is higher (e.g., increased bandwidth, faster connection speed), the computing device (or component thereof) can obtain a higher resolution feature map as compared to when the quality of connection between the first device and the second device is lower (e.g., reduced bandwidth, slower connection speed, etc.). In some examples, the computing device (or component thereof) can determine to use a first decoder from a plurality of decoders based on the quality of connection between the first device and the second device or the task to be performed using the combined feature map. For example, the computing device can include multiple decoders, such as a first decoder (e.g., the first decoder 220 of FIG. 2) and a second decoder (e.g., the second decoder 222 of FIG. 2).

At block 706, the computing device (or component thereof) can process the first feature map and the second feature map to generate a combined feature map based on the metadata. In such an example, the combined feature map can include a concatenation or cross-attention combination of the first feature map and the second feature map. In some aspects, the metadata can include an indication to use concatenation or the cross-attention combination to combine the second feature map with the at least one other feature map, such as the first feature map. For example, the indication can include instructions for the computing device (or component thereof) to use concatenation or the cross-attention combination to combine the second feature map with at least one other feature map. In some examples where the combined feature map uses a cross-attention combination of the first feature map and the second feature map, the first feature map can be used as queries and the second feature map can be used as keys and values to a cross-attention layer of a decoder. In such an example, the computing device (or component thereof) can process the keys, the values, and the queries using the cross-attention layer of the decoder to perform the task (e.g., the task performed at block 708).

At block 708, the computing device (or component thereof) can process the combined feature map to perform a task. For example, the computing device (or component thereof) can provide the combined feature map to a machine learning model or layer of a machine learning model to perform the task. In some examples, the task can include image classification, object detection, sentiment analysis of text, autonomous driving, etc. The various tasks can use different resolution feature maps based on the different tasks. In some aspects, the plurality of feature maps can be associated with a plurality of layers of varying quality (e.g., different resolutions). For example, the first feature map and the second feature map can be layers of the combined feature map, with the first feature map and the second feature map having different resolutions and different features. In such an example, the first feature map can be associated with one or more layers of the plurality of layers. In further aspects, the computing device (or component thereof) can receive a response from the first device. In such an example, the response can include an output of a machine learning model of the first device. In further examples, the response can be based on an enhancement to the first feature map or to the second feature map by adding an additional layer to the first feature map or the second feature map. For example, the first feature map or the second feature map can be enhanced (e.g., increasing resolution) by adding an additional layer to the first feature map or the second feature map.

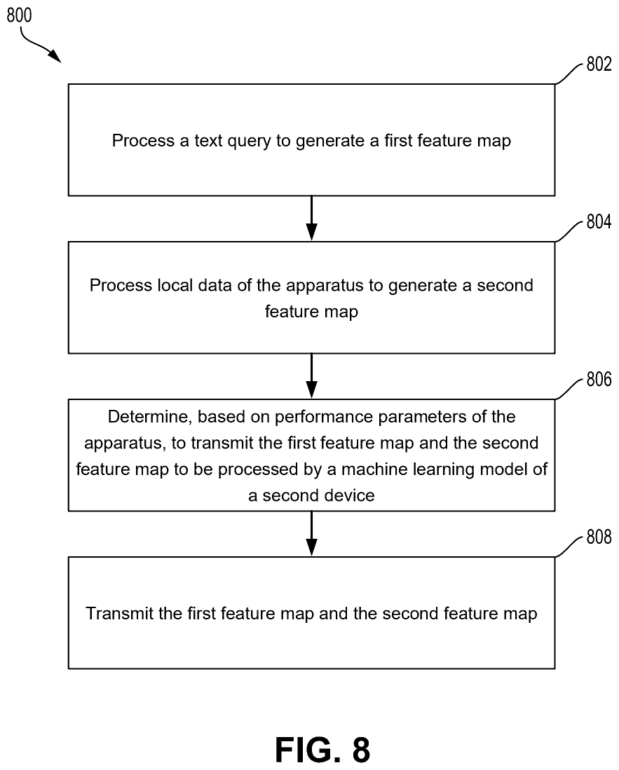

FIG. 8 is a flow chart illustrating an example of a process 800 for machine learning processing. The process 700 can be performed by a computing device (e.g., SOC 100 of FIG. 1, computing device or computing system 1200 of FIG. 12, etc.) or by a component or system (e.g., receiving device 204 or transmitting device 202 of FIG. 2, the compression system 400 of FIG. 4, the decoder 500 of FIG. 5, the neural network 900 of FIG. 9, the convolutional neural network 1000 of FIG. 10, the transformer 1100 of FIG. 11, etc.), a chipset, one or more processors central processing units (CPUs), digital signal processors (DSPs), graphics processing units (GPUs), any other type of processor(s), any combination thereof, or other component or system) of the computing device. The operations of the process 700 can be implemented as software components that are executed and run on one or more processors (e.g., processor 1210 of FIG. 12 or other processor(s)) of the computing device. Further, the transmission and reception of signals by the computing device in the process 700 can be enabled, for example, by one or more antennas, one or more microphones, and/or one or more transceivers (e.g., wireless transceiver(s)).

At block 802, the computing device (or component thereof) can process a text query to generate a first feature map. For example, the text query can be a request to perform a task using a machine learning model. In such an example, an apparatus (e.g., the computing device or component thereof) can generate the first feature map based on the text query. For example, the user can provide an input to the computing device, such as a typed query associated with a task to be performed. In some examples, the computing device (or component thereof) can use an encoder to generate the first feature map.

At block 804, the computing device (or component thereof) can process local data of the apparatus to generate a second feature map. For example, the local data can be data from a sensor of the computing device (or component thereof). In such an example, the computing device can include a sensor, such as a camera, microphone, etc. The computing device can generate local data (e.g., sensor data) using the sensors and store the local data in memory of the computing device. The computing device (or component thereof) can use an encoder to process the local data to generate the second feature map. In some examples, the computing device (or component thereof) can process the local data using a separate encoder from the encoder used to process the text query.

At block 806, the computing device (or component thereof) can determine, based on performance parameters of an apparatus (e.g., performance parameters of the computing device or component thereof) to be performed from the text query, to transmit the first feature map and the second feature map to be processed by a machine learning model of a second device. In some examples, performance parameters can include information associated with operation of the computing device (or component thereof) such as one or more of a current compute load, remaining battery power of the computing device, or temperature of the computing device. In some examples, the determination to transmit the first feature map and the second feature map to be processed by the machine learning model of the first device (e.g., the computing device) can be based on a quality of a connection between the first device and the second device. For example, the first device can include a machine learning model, and the second device can include another machine learning model. In some examples, the computing device (or component thereof) can determine which device and machine learning model to use based on the quality of the connection between devices and performance parameters of the first device (e.g., the computing device). When the quality of the connection is lower (e.g., lower bandwidth, lower connection speed, etc.), the computing device can determine to process the first feature map and the second feature map using a local machine learning model (e.g., a machine learning model of the computing device). When the quality of the connection is higher (e.g., bandwidth above a bandwidth threshold or connection speed above a connection speed threshold, etc.), the computing device can determine to process the first feature map and the second feature map using a machine learning model of the second device. For example, the second device can be an edge device, cloud service, server, etc.

At block 808, the computing device (or component thereof) can transmit the first feature map and the second feature map. In further examples, the computing device (or component thereof) can compress the first feature map and the second feature map. In such an example, the transmitted first feature map and the transmitted second feature map are compressed representations of the first feature map and the second feature map. In some examples, the first feature map and the second feature map can be transmitted using a real-time transport protocol (RTP) packet associated with a quality level of the first feature map and the second feature map. In further examples, the RTP packet can include an RTP header extension indicating layer information of the first feature map or the second feature map. In another example, the RTP packet can include a payload type indicating parameters of the first feature map or the second feature map. The parameters can include a computing graph, a layer identity, and quantization parameters of the first feature map or the second feature map. In further examples, the computing device (or component thereof) can receive a response from the second device. In such an example, the response can be an output of the machine learning model of the second device. In further examples, the response can be based on an enhancement to the first feature map or to the second feature map by adding an additional layer to the first feature map or the second feature map.

As noted above, various aspects of the present disclosure can use machine learning models or systems. FIG. 9 is an illustrative example of a deep learning neural network 900 that can be used to implement the machine learning based feature extraction and/or activity recognition (or classification) described above. An input layer 920 includes input data. In one illustrative example, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n.

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more data is processed.

The neural network 900 can be pre-trained to process the features from the data in the input layer 920 using the different hidden layers 922a, 922b, through 922n in order to provide the output through the output layer 924.

In some cases, the neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of reducing noise in audio signals, the forward pass can include passing training data through the neural network 900. The weights are initially randomized before the neural network 900 is trained. As an illustrative example, an audio signal can include an array of numbers representing a sequence of sounds. Each number in the array can include a numerical value representing sounds in sequence. In one example, the array is a one-dimensional sequence of numbers.

As noted above, for a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training data since the actual values will be much different than the predicted output. The goal of training is to minimize the amount of loss so that the predicted output is the same as the training label. The neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and f denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

FIG. 10 is an illustrative example of a convolutional neural network (CNN) 1000. FIG. 10 provides an example for operation of a convolutional neural network (CNN) 1000 on images and video, however the structure of the convolutional neural network (CNN) may be further adapted to receive one-dimensional inputs such as audio signals. The input layer 1020 of the CNN 1000 includes data representing an image or frame. For example, the data can include an array of numbers representing the pixels of the image, with each number in the array including a value from 0 to 255 describing the pixel intensity at that position in the array. For example, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. The output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is one example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling hidden layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling hidden layer 1022b (which should represent the activation maps of high-level features) and determines the features that most correlate to a particular class. For example, the fully connected layer 1022c layer can determine the high-level features that most strongly correlate to a particular class and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=10). M indicates the number of classes that the CNN 1000 can choose from when classifying the sounds in an audio recording. Other example outputs can also be provided. Each number in the M-dimensional vector can represent the probability the object is of a certain class. In one illustrative example, if a 10-dimensional output vector represents ten different classes of sounds is [0 0 0.05 0.8 0 0.15 0 0 0 0], the vector indicates that there is a 5% probability that the audio includes a third class of sound (e.g., a trumpet), an 80% probability that the audio includes a fourth class of sound (e.g., a human voice), and a 15% probability that the audio includes a sixth class of sound (e.g., a bird chirping). The probability for a class can be considered a confidence level that the object is part of that class.

FIG. 11 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 1100 reduces the operations of learning dependencies by using an encoder 1110 and a decoder 1130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1110 is composed of a stack of six identical layers and each layer has two sub-layers. The first sub-layer is a multi-head self-attention engine 1112, and the second sub-layer is a fully connected feed-forward network 1114. A residual connection (not shown) connects around each of the sub-layers followed by normalization.

In this example transformer 1100, the decoder 1130 is also composed of a stack of six 6 identical layers. The decoder also includes a masked multi-head self-attention engine 1132, a multi-head attention engine 1134 over the output of the encoder 1110, and a fully connected feed-forward network 1126. Each layer includes a residual connection (not shown) around the layer, which is followed by layer normalization. The masked multi-head self-attention engine 1132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1140 to encode positions because the model does not contain recurrence and convolution, and relative or absolute position of the tokens is needed. In the transformer 1100, the positional encodings are added to the input embeddings at the bottom layer of the encoder 1110 and the decoder 1130. The positional encodings are summed with the embeddings because the positional encodings and embeddings have the same dimensions. A corresponding position decoder 1150 is configured to decode the positions of the embeddings for the decoder 1130.

In some aspects, the transformer 1100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1100 can process input sequences of variable length, making it well-suited for natural language processing tasks where input lengths can vary greatly. Additionally, the self-attention mechanism allows the transformer 1100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory, or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus of a first device for machine learning processing, the apparatus comprising: at least one memory; and at least one processor coupled to the at least one memory and configured to: process, using an encoder, data stored in the at least one memory of the apparatus to generate a first feature map; obtain a second feature map from a plurality of feature maps associated with processed data from a second device, wherein the second feature map includes metadata indicating how to combine the second feature map with at least one other feature map; process the first feature map and the second feature map to generate a combined feature map based on the metadata, wherein the combined feature map is a concatenation or cross-attention combination of the first feature map and the second feature map; and process the combined feature map to perform a task.

Aspect 2. The apparatus of Aspect 1, wherein the metadata includes an indication to use concatenation or the cross-attention combination to combine the second feature map with the at least one other feature map.

Aspect 3. The apparatus of any of Aspects 1 to 2, wherein the cross-attention combination of the first feature map and the second feature map includes the first feature map as queries and the second feature map as keys and values to a cross-attention layer of a decoder; and wherein, to process the combined feature map to perform the task, the at least one processor is configured to process the keys, the values, and the queries using the cross-attention layer of the decoder.

Aspect 4. The apparatus of any of Aspects 2 to 3, wherein the plurality of feature maps are different resolutions.

Aspect 5. The apparatus of any of Aspects 2 to 4, wherein the at least one processor is configured to: receive a response from the first device, wherein the response is an output of a machine learning model of the first device and the response is based on an enhancement to the first feature map or to the second feature map by adding an additional layer to the first feature map or the second feature map.

Aspect 6. The apparatus of any of Aspects 2 to 5, wherein the plurality of feature maps are associated with a plurality of layers of varying quality, and wherein the first feature map is associated with one or more layers of the plurality of layers.

Aspect 7. The apparatus of any of Aspects 2 to 6, wherein the plurality of layers of varying quality includes different resolutions, and wherein the second feature map is obtained based on the task to be performed using the combined feature map.

Aspect 8. The apparatus of any of Aspects 2 to 7, wherein the second feature map from the plurality of feature maps is obtained based on a quality of a connection between the first device and the second device.

Aspect 9. The apparatus of Aspect 8, wherein the at least one processor is configured to: determine to use a first decoder from a plurality of decoders based on the quality of connection between the first device and the second device or the task to be performed using the combined feature map.

Aspect 10. The apparatus of any of Aspects 2 to 9, wherein the apparatus is the first device or is part of the first device.

Aspect 11. An apparatus of a first device for machine learning processing, the apparatus comprising: at least one memory; and at least one processor coupled to the at least one memory and configured to: process a text query to generate a first feature map; process local data of the apparatus to generate a second feature map; determine, based on performance parameters of the apparatus, to transmit the first feature map and the second feature map to be processed by a machine learning model of a second device; and transmit the first feature map and the second feature map.

Aspect 12. The apparatus of Aspect 11, wherein the performance parameters of the apparatus include one or more of a current compute load, remaining battery power of the apparatus, or temperature of the apparatus.

Aspect 13. The apparatus of any of Aspects 11 to 12, wherein the determination to transmit the first feature map and the second feature map to be processed by the machine learning model of the first device is further based on a quality of a connection between the first device and the second device.

Aspect 14. The apparatus of any of Aspects 11 to 13, wherein the at least one processor is configured to: compress the first feature map and the second feature map, and wherein the transmitted first feature map and the transmitted second feature map are compressed representations of the first feature map and the second feature map.

Aspect 15. The apparatus of any of Aspects 11 to 14, wherein the first feature map and the second feature map are transmitted using a real-time transport protocol (RTP) packet associated with a quality level of the first feature map and the second feature map.

Aspect 16. The apparatus of any of Aspects 11 to 15, wherein the RTP packet includes an RTP header extension indicating layer information of the first feature map or the second feature map.

Aspect 17. The apparatus of any of Aspects 11 to 16, wherein the RTP packet includes a payload type indicating parameters of the first feature map or the second feature map.

Aspect 18. The apparatus of any of Aspects 11 to 17, wherein the parameters include a computing graph, a layer identity, and quantization parameters of the first feature map or the second feature map.

Aspect 19. The apparatus of any of Aspects 11 to 18, wherein the at least one processor is configured to: receive a response from the second device, wherein the response is an output of the machine learning model of the second device and the response is based on an enhancement to the first feature map or to the second feature map by adding an additional layer to the first feature map or the second feature map.

Aspect 20. A method comprising: processing, using an encoder, data stored in memory of a first device to generate a first feature map; obtaining a second feature map from a plurality of feature maps associated with processed data from a second device, wherein the second feature map includes metadata indicating how to combine the second feature map with at least one other feature map; processing the first feature map and the second feature map to generate a combined feature map based on the metadata, wherein the combined feature map is a concatenation or cross-attention combination of the first feature map and the second feature map; and processing the combined feature map to perform a task.

Aspect 21. The method of Aspect 20, wherein the metadata includes an indication to use concatenation or the cross-attention combination to combine the second feature map with the at least one other feature map.

Aspect 22. The method of any of Aspects 20 to 21, wherein the cross-attention combination of the first feature map and the second feature map includes the first feature map as queries and the second feature map as keys and values to a cross-attention layer of a decoder; and wherein, processing the combined feature map to perform the task includes processing the keys, the values, and the queries using the cross-attention layer of the decoder.

Aspect 23. The method of any of Aspects 20 to 22, wherein the plurality of feature maps are different resolutions.

Aspect 24. The method of any of Aspects 20 to 23, further comprising: receiving a response from the first device, wherein the response is an output of a machine learning model of the first device and the response is based on an enhancement to the first feature map or to the second feature map by adding an additional layer to the first feature map or the second feature map.

Aspect 25. The method of any of Aspects 20 to 24, wherein the plurality of feature maps are associated with a plurality of layers of varying quality, and wherein the first feature map is associated with one or more layers of the plurality of layers.

Aspect 26. The method of any of Aspects 20 to 25, wherein the plurality of layers of varying quality includes different resolutions, and wherein the second feature map is obtained based on the task to be performed using the combined feature map.

Aspect 27. The method of any of Aspects 20 to 26, wherein the second feature map from the plurality of feature maps is obtained based on a quality of a connection between the first device and the second device.

Aspect 28. The method of Aspect 27, further comprising: determining to use a first decoder from a plurality of decoders based on the quality of connection between the first device and the second device or the task to be performed using the combined feature map.

Aspect 29. The method of any of Aspects 20 to 28, wherein the apparatus is the first device or is part of the first device.

Aspect 30. A method comprising: processing a text query to generate a first feature map; processing local data of a first device to generate a second feature map; determining, based on performance parameters, to transmit the first feature map and the second feature map to be processed by a machine learning model of a second device; and transmitting the first feature map and the second feature map.

Aspect 31. The method of Aspect 30, wherein the performance parameters include one or more of a current compute load, remaining battery power of the apparatus, or temperature of the apparatus.

Aspect 32. The method of any of Aspects 30 to 31, wherein the determination to transmit the first feature map and the second feature map to be processed by the machine learning model of the first device is further based on a quality of a connection between the first device and the second device.

Aspect 33. The method of any of Aspects 30 to 32, further comprising: compressing the first feature map and the second feature map, and wherein the transmitted first feature map and the transmitted second feature map are compressed representations of the first feature map and the second feature map.

Aspect 34. The method of any of Aspects 30 to 33, wherein the first feature map and the second feature map are transmitted using a real-time transport protocol (RTP) packet associated with a quality level of the first feature map and the second feature map.

Aspect 35. The method of any of Aspects 30 to 34, wherein the RTP packet includes an RTP header extension indicating layer information of the first feature map or the second feature map.

Aspect 36. The method of any of Aspects 30 to 35, wherein the RTP packet includes a payload type indicating parameters of the first feature map or the second feature map.

Aspect 37. The method of any of Aspects 30 to 36, wherein the parameters include a computing graph, a layer identity, and quantization parameters of the first feature map or the second feature map.

Aspect 38. The method of any of Aspects 30 to 37, further comprising receiving a response from the second device, wherein the response is an output of the machine learning model of the second device and the response is based on an enhancement to the first feature map or to the second feature map by adding an additional layer to the first feature map or the second feature map.

Aspect 39. A non-transitory computer-readable medium having stored thereon instructions that, when executed by at least one processor, cause the at least one processor to perform one or more of operations according to any of Aspects 20 to 29.

Aspect 40. An apparatus for wireless communication, the apparatus comprising one or more means for performing operations according to any of Aspects 20 to 29.

Aspect 41. A non-transitory computer-readable medium having stored thereon instructions that, when executed by at least one processor, cause the at least one processor to perform one or more of operations according to any of Aspects 30 to 38.

Aspect 42. An apparatus for wireless communication, the apparatus comprising one or more means for performing operations according to any of Aspects 30 to 38.

What is claimed is:

1. An apparatus of a first device for machine learning processing, the apparatus comprising:
at least one memory; and
at least one processor coupled to the at least one memory and configured to:
process, using an encoder, data stored in the at least one memory of the apparatus to generate a first feature map;
obtain a second feature map from a plurality of feature maps associated with processed data from a second device, wherein the second feature map includes metadata indicating how to combine the second feature map with at least one other feature map;
process the first feature map and the second feature map to generate a combined feature map based on the metadata, wherein the combined feature map is a concatenation or cross-attention combination of the first feature map and the second feature map; and
process the combined feature map to perform a task.

2. The apparatus of claim 1, wherein the metadata includes an indication to use concatenation or the cross-attention combination to combine the second feature map with the at least one other feature map.

3. The apparatus of claim 1, wherein the cross-attention combination of the first feature map and the second feature map includes the first feature map as queries and the second feature map as keys and values to a cross-attention layer of a decoder; and
wherein, to process the combined feature map to perform the task, the at least one processor is configured to process the keys, the values, and the queries using the cross-attention layer of the decoder.

4. The apparatus of claim 1, wherein the plurality of feature maps are different resolutions.

5. The apparatus of claim 1, wherein the at least one processor is configured to:
receive a response from the first device, wherein the response is an output of a machine learning model of the first device and the response is based on an enhancement to the first feature map or to the second feature map by adding an additional layer to the first feature map or the second feature map.

6. The apparatus of claim 1, wherein the plurality of feature maps are associated with a plurality of layers of varying quality, and wherein the first feature map is associated with one or more layers of the plurality of layers.

7. The apparatus of claim 6, wherein the plurality of layers of varying quality includes different resolutions, and wherein the second feature map is obtained based on the task to be performed using the combined feature map.

8. The apparatus of claim 1, wherein the second feature map from the plurality of feature maps is obtained based on a quality of a connection between the first device and the second device.

9. The apparatus of claim 8, wherein the at least one processor is configured to:
determine to use a first decoder from a plurality of decoders based on the quality of connection between the first device and the second device or the task to be performed using the combined feature map.

10. The apparatus of claim 1, wherein the apparatus is the first device or is part of the first device.

11. An apparatus of a first device for machine learning processing, the apparatus comprising:
at least one memory; and
at least one processor coupled to the at least one memory and configured to:
process a text query to generate a first feature map;
process local data of the apparatus to generate a second feature map;
determine, based on performance parameters of the apparatus, to transmit the first feature map and the second feature map to be processed by a machine learning model of a second device; and
transmit the first feature map and the second feature map.

12. The apparatus of claim 11, wherein the performance parameters of the apparatus include one or more of a current compute load, remaining battery power of the apparatus, or temperature of the apparatus.

13. The apparatus of claim 11, wherein the determination to transmit the first feature map and the second feature map to be processed by the machine learning model of the first device is further based on a quality of a connection between the first device and the second device.

14. The apparatus of claim 11, wherein the at least one processor is configured to:
compress the first feature map and the second feature map, and wherein the transmitted first feature map and the transmitted second feature map are compressed representations of the first feature map and the second feature map.

15. The apparatus of claim 11, wherein the first feature map and the second feature map are transmitted using a real-time transport protocol (RTP) packet associated with a quality level of the first feature map and the second feature map.

16. The apparatus of claim 15, wherein the RTP packet includes an RTP header extension indicating layer information of the first feature map or the second feature map.

17. The apparatus of claim 15, wherein the RTP packet includes a payload type indicating parameters of the first feature map or the second feature map.

18. The apparatus of claim 17, wherein the parameters include a computing graph, a layer identity, and quantization parameters of the first feature map or the second feature map.

19. The apparatus of claim 11, wherein the at least one processor is configured to:
receive a response from the second device, wherein the response is an output of the machine learning model of the second device and the response is based on an enhancement to the first feature map or to the second feature map by adding an additional layer to the first feature map or the second feature map.

20. A method comprising:
processing, using an encoder, data stored in memory of a first device to generate a first feature map;
obtaining a second feature map from a plurality of feature maps associated with processed data from a second device, wherein the second feature map includes metadata indicating how to combine the second feature map with at least one other feature map;
processing the first feature map and the second feature map to generate a combined feature map based on the metadata, wherein the combined feature map is a concatenation or cross-attention combination of the first feature map and the second feature map; and
processing the combined feature map to perform a task.
